(19) United States
(12) Patent Application Publication
(10) Pub. No.: US 2009/0092030 A1
(43) Pub. Date: Apr. 9, 2009

(54) Optical disk device

(75) Inventors: Tadashi Jahana, Kanagawa (JP); Seiji Kawata, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC Electronics Corporation, Kawasaki (JP)

(21) Appl. No.: 12/232,043

(22) Filed: Sep. 10, 2008

(30) Foreign Application Priority Data
Oct. 9, 2007 (JP) 2007-263387

(51) Int. Cl. G11B 7/00

(52) U.S. Cl. 369/112.04; G9B/7

(57) ABSTRACT

Provided is an optical disk device to output a reproduction signal to reproduce an optical disk, including: a light output circuit to output light having a high frequency superimposed thereon; a first light receiving circuit to receive the light to output a first voltage corresponding to an amount of the light; a second light receiving circuit to output a second voltage corresponding to an amount of reflected light from the optical disk; an arithmetic circuit to output a calculation result based on a difference between the first voltage and the second voltage; and a reproduction signal generating circuit to control one of the first voltage and the second voltage based on the calculation result to generate the reproduction signal to reproduce the optical disk.

### BACKGROUND OF THE INVENTION

1. Field of the Invention

The present invention relates to an optical disk device and, more particularly, to an optical disk device for irradiating an optical disk with laser light output from a semiconductor laser to reproduce the optical disk based on reflected light from the optical disk.

2. Description of Related Art

An optical disk device irradiates a disk-like recording medium with a light beam to reproduce an optical disk based on reflected light from the optical disk. A semiconductor laser is generally used as a light source for applying light beams. Laser light output from the semiconductor laser is made incident on the optical disk, and apart of the laser light reflected by the optical disk is returned to the semiconductor laser as a return light. In this case, when the phase of the laser light output from the semiconductor laser matches the phase of the return light reflected by the optical disk, the lights interfere with each other and strengthen each other. On the other hand, when the phase of the laser light output from the semiconductor laser is different from that of the return light reflected by the optical disk by 180 degrees, the lights are weakened. The phase of the laser light output from the semiconductor laser and the phase of the return light reflected by the optical disk fluctuate based on wobbling of the optical disk or the like. In other words, noise is generated in the semiconductor laser (hereinafter, referred to as “laser noise”) due to the return light reflected by the optical disk based on wobbling of the optical disk or the like. An optical disk device for reducing the laser noise is disclosed in Japanese Unexamined Patent Application Publication No. 06-267102.

FIG. 4 shows an optical disk device 40 disclosed in Japanese Unexamined Patent Application Publication No. 06-267102. In an optical head 41, a light beam emitted from a semiconductor laser 42 is split into two light beams. One of the two light beams is made incident on an optical disk 44 via an objective lens 43, and the other of the two light beams is input to a photodetector 45. The photodetector 45 outputs a monitor current in response to the intensity of the light beam output from the semiconductor laser 42, to an auto power control (APC) circuit 46. The APC circuit 46 compares a voltage corresponding to the monitor current output from the photodetector 45 with a reference potential, thereby controlling the amount of light beams output from the semiconductor laser 42. A laser noise reduction circuit 47 calculates a residual laser noise signal Vp generated based on an output signal Vn output from the APC circuit 46, and a reproduction signal Vs corresponding to information recorded on the optical disk 44, and outputs a reproduction signal Vo with suppressed laser noise.

Specifically, in the optical disk device 40 disclosed in Japanese Unexamined Patent Application Publication No. 06-267102, the APC circuit 46 controls the amount of light beams output from the semiconductor laser 42. Thus, in the optical disk device 40, the laser noise generated in the semiconductor laser 42 is reduced. Further, in the optical disk device 40, the laser noise reduction circuit 47 is provided so as to further suppress noise components that cannot be reduced by the APC circuit 46.

FIG. 5 shows an optical disk device 50 disclosed in Japanese Unexamined Patent Application Publication No. 06-267102. It is noted that the configuration of the optical head 41 shown in FIG. 5 is identical with the configuration of the optical head shown in FIG. 4, so a detailed description thereof is omitted. An APC circuit 51 divides a voltage signal converted based on the monitor current output from the photodetector 45 into two output signals. One of the two output signals is used as a signal for controlling the amount of light beams output from the semiconductor laser 42. The other of the two output signals is input to a laser noise monitor signal generating circuit 53 via a buffer amplifier 52. Then, the laser noise monitor signal generating circuit 53 generates a laser noise monitor signal Vm based on the received output signal. An arithmetic circuit 54 calculates the laser noise monitor signal Vm and the reproduction signal Vs corresponding to information recorded on the optical disk 44, and outputs the reproduction signal Vo with suppressed laser noise. Specifically, in the optical disk device 50 disclosed in Japanese Unexamined Patent Application Publication No. 06-267102, the laser noise monitor signal Vm generated based on the output signal output from the APC circuit 51 cancels and eliminates the laser noise contained in the reproduction signal Vs.

Meanwhile, there is conventionally known a technique of superimposing a high-frequency signal on laser light output from a semiconductor laser to emit the laser light in a multi mode, thereby reducing the laser noise. Specifically, the intensity of laser light is adjusted so that the return light becomes maximum when the intensity of the laser light output from the semiconductor laser is weak, and that the return light becomes minimum when the intensity of the laser beam is strong. In short, the high-frequency signal is superimposed on the laser light output from the semiconductor laser, thereby adjusting the intensity of the laser light. Thus, the semiconductor laser is oscillated in the multi mode, which results in reduction of the fluctuation in the amount of laser beams and reduction of the laser noise. In the optical disk device 50 disclosed in Japanese Unexamined Patent Application Publication No. 06-267102, even if the high-frequency signal is superimposed on the laser light output from the semiconductor laser, the laser noise can be suppressed.

In the optical disk device 40 disclosed in Japanese Unexamined Patent Application Publication No. 06-267102, however, it is difficult to operate the APC circuit 46 in the high-frequency region. Further, in the optical disk device 40, if the APC circuit 46 is operated in the high-frequency region, light is emitted so as to cancel a variation in the amount of light of the semiconductor laser 42. As a result, in the optical disk device 40 disclosed in Japanese Unexamined Patent Application Publication No. 06-267102, if the APC circuit 46 is operated in the high-frequency region, there arises a problem in that the laser noise rather increases.

Furthermore, in the optical disk device 50 disclosed in Japanese Unexamined Patent Application Publication No. 06-267102, a phase error is generated between the reproduction signal Vs and the laser noise monitor signal Vm due to variations in elements of loop filters 55 and 56 and the buffer amplifier 52. In other words, in the optical disk device 50, it is difficult to adjust the phase of a high-frequency superimposed component to be suppressed. Accordingly, in the optical disk device 50 disclosed in Japanese Unexamined Patent Application Publication No. 06-267102, it is difficult to accurately suppress the laser noise generated in the semiconductor laser in the high-frequency region.

As described above, it is difficult for the conventional optical disk devices to sufficiently reduce the laser noise generated in the semiconductor laser in the high-frequency region.

### SUMMARY

In one embodiment of the present invention, there is provided an optical disk device to output a reproduction signal to reproduce an optical disk, including: a light output circuit to output light having a high frequency superimposed thereon; a first light receiving circuit to receive the light to output a first voltage corresponding to an amount of the light; a second light receiving circuit to output a second voltage corresponding to an amount of reflected light from the optical disk; an arithmetic circuit to output a calculation result based on a difference between the first voltage and the second voltage; and a reproduction signal generating circuit to control one of the first voltage and the second voltage based on the calculation result to generate the reproduction signal to reproduce the optical disk.

In the optical disk device according to one embodiment of the present invention, the first voltage corresponding to laser light output from a semiconductor laser and the second voltage corresponding to reflected light from an optical disk are calculated, and one of the first voltage and the second voltage is controlled based on the calculation result, thereby making it possible to output a reproduction signal for reproducing the optical disk.

According to the present invention, it is possible to provide an optical disk device capable of sufficiently reducing laser noise generated in a semiconductor laser in a high-frequency region.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 shows an optical disk device 100 according to a first embodiment of the present invention;

FIG. 2 shows an optimization control circuit provided in the optical disk device 100 according to the first embodiment;

FIG. 3 shows a first light receiving circuit provided in an optical disk device 200 according to a second embodiment of the present invention;

FIG. 4 shows an optical disk device 40 disclosed in Japanese Unexamined Patent Application Publication No. 06-267102; and

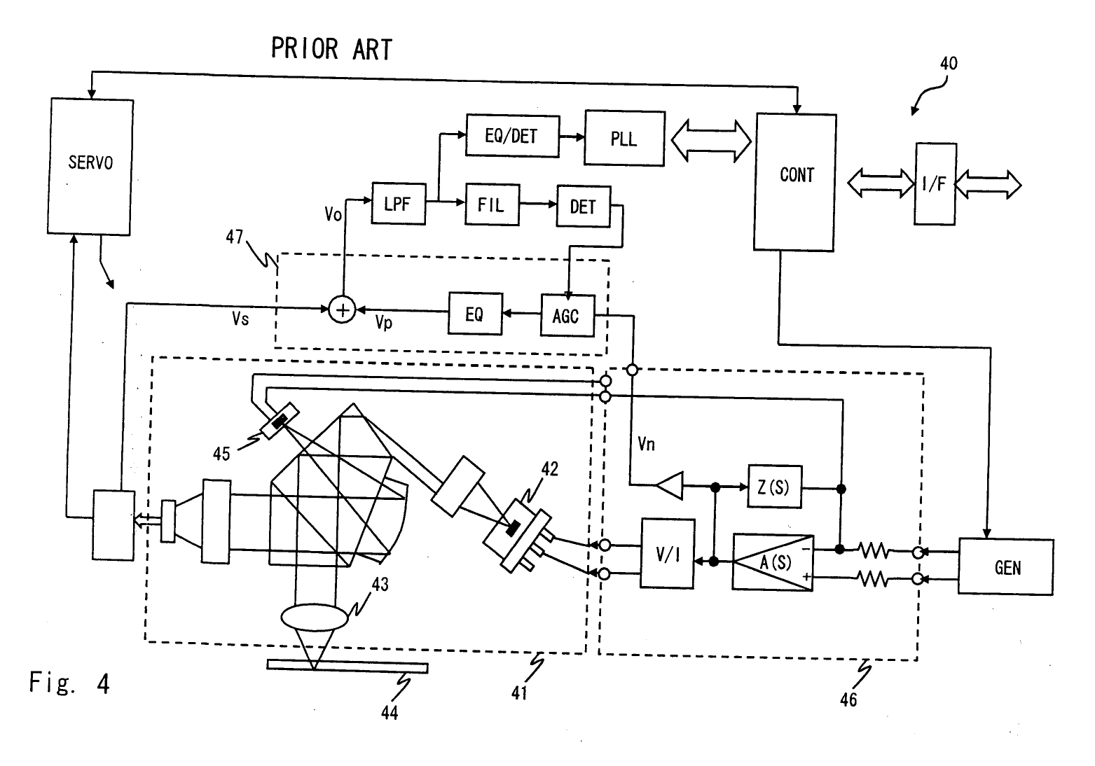

FIG. 5 shows an optical disk device 50 disclosed in Japanese Unexamined Patent Application Publication No. 06-267102.

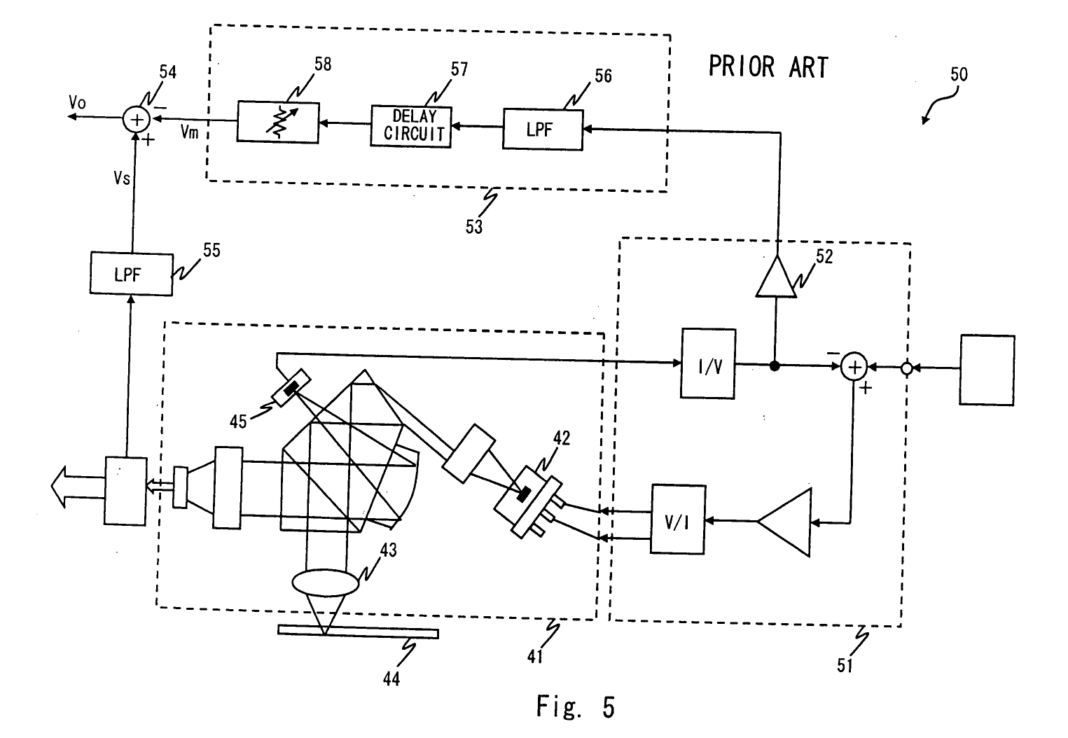

### DETAILED DESCRIPTION OF THE PREFERRED EMBODIMENTS

The invention will now be described herein with reference to illustrative embodiments. Those skilled in the art will recognize that many alternative embodiments can be accomplished using the teachings of the present invention and that the invention is not limited to the embodiments illustrated for explanatory purposes.

### First Embodiment

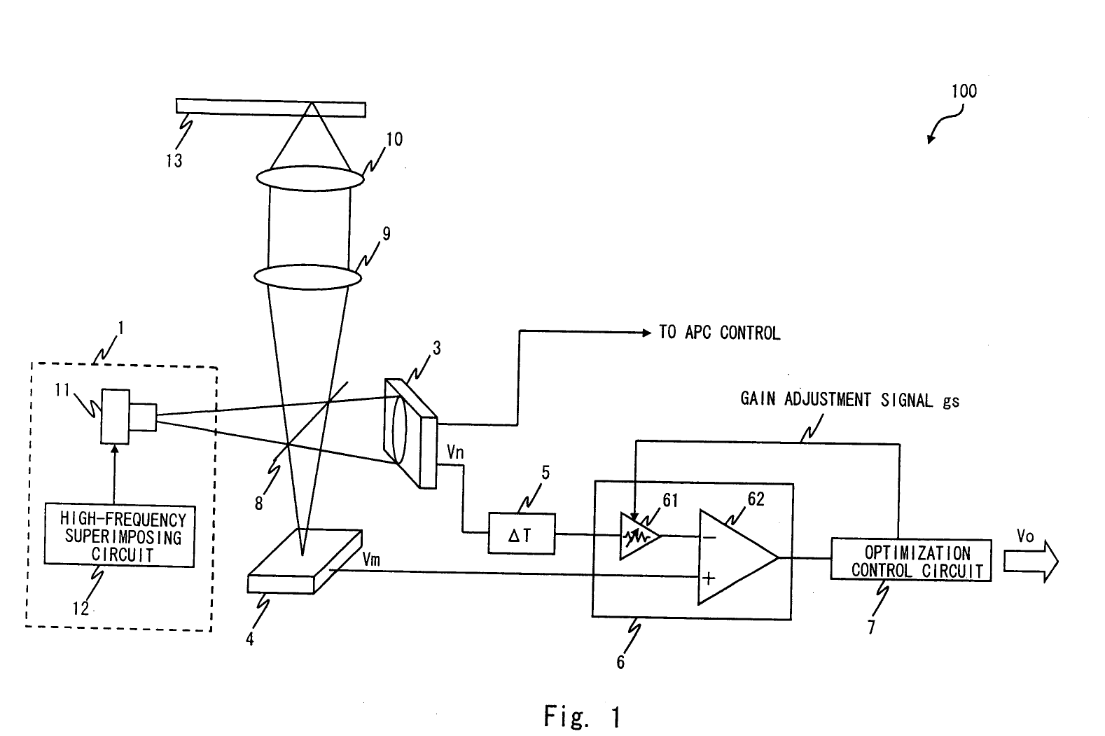

Hereinafter, embodiments of the present invention will be described with reference to the drawings. FIG. 1 shows an optical disk device according to a first embodiment of the present invention. As shown in FIG. 1, an optical disk device 100 according to the first embodiment includes a laser light output circuit 1, a first light receiving circuit (hereinafter, referred to as “light receiving circuit 3”), a second light receiving circuit (hereinafter, referred to as “light receiving circuit 4”), a phase error correcting circuit (hereinafter, referred to as “delay element”) 5, an arithmetic circuit 6, a reproduction signal generating circuit (hereinafter, referred to as “optimization control circuit”) 7, a half mirror 8, a collimator lens 9, and an imaging lens 10.

The laser light output circuit 1 outputs laser light that fluctuates according to the fluctuation of an optical disk. The laser light output circuit 1 includes a semiconductor laser 11 and a high-frequency superimposing circuit 12. The semiconductor laser 11 oscillates a laser light in an infrared range or a visible light range. The high-frequency superimposing circuit 12 applies a high-frequency signal to the laser light output from the semiconductor laser 11. The high-frequency superimposing circuit 12 oscillates the semiconductor laser 11 in a multi mode to superimpose a high-frequency signal of about 350 MHz to 450 MHz, for example. Note that a self-excited emission laser may be used as the semiconductor laser 11. In this case, there is no need to provide the high-frequency superimposing circuit 12 in the laser light output circuit 1.

The half mirror 8 splits light of a specific wavelength range into transmitted light and reflected light at an arbitrary ratio, to thereby adjust the amount of light. In the first embodiment, the laser light, on which the high-frequency signal output from the laser light output circuit 1 is superimposed, enters the half mirror 8. Then, the light receiving circuit 3 is irradiated with the laser light transmitting through the half mirror 8. On the other hand, the laser light reflected by the half mirror 8 forms an image on a signal surface of an optical disk 13 via the collimator lens 9, an optical element (not shown) such as a λ/4 (¼ wavelength) plate, and the imaging lens 10.

The light receiving circuit 3 receives the laser light output from the laser light output circuit 1 via the half mirror 8, and outputs a first voltage Vn in response to the amount of laser light. In the first embodiment, the light receiving circuit 3 includes a photodiode (not shown) and a current/voltage conversion (I/V) circuit (not shown). Specifically, in the light receiving circuit 3, the photodiode converts the laser beam output from the semiconductor laser 1, into a current. Then, the current/voltage conversion circuit converts the current output from the photodiode, into a voltage to be output. Note that the light receiving circuit 3 has a wider bandwidth so as to deal with the laser light on which the high-frequency signal is superimposed.

The light receiving circuit 4 receives the return light reflected from the optical disk 13 via the imaging lens 10, the collimator lens 9, and a cylindrical lens (not shown), and outputs a second voltage Vm in response to the amount of the return light. The light receiving circuit 4 includes a photodiode (not shown) and a current/voltage conversion (I/V) circuit (not shown), like the light receiving circuit 3. Specifically, in the light receiving circuit 4, the photodiode converts the return light reflected from the optical disk 13 into a current. Then, the current/voltage conversion circuit converts the current output from the photodiode, into a voltage to be output. Note that the light receiving circuit 4 has a wider bandwidth so as to deal with the laser light on which the high-frequency signal is superimposed. The delay element 5 delays a change in voltage level of the first voltage Vn output from the light receiving circuit 3, and outputs the first voltage Vn thus obtained.

The arithmetic circuit 6 calculates the first voltage Vn output from the light receiving circuit 3, and the second voltage Vm output from the light receiving circuit 4. The arithmetic circuit 6 includes a gain adjustment circuit 61 and an operational amplifier 62. An input of the gain adjustment circuit 61 is connected to an output of the delay element 5, and an output of the gain adjustment circuit 61 is connected to an inverted input terminal of the operational amplifier 62. Further, a non-inverted input terminal of the operational amplifier 62 is connected to an output of the light receiving circuit 4.

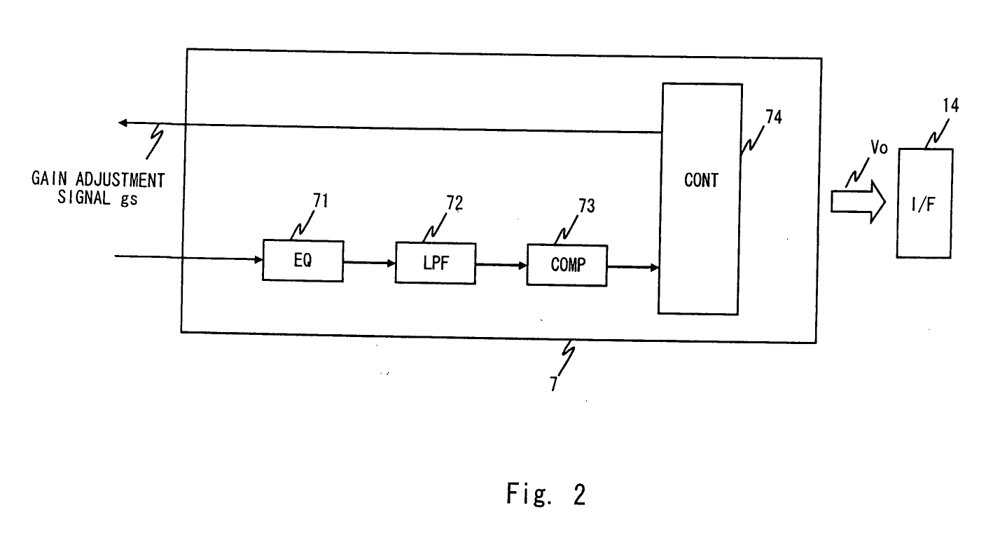

The optimization control circuit 7 optimizes and outputs a reproduction signal for reproducing the optical disk 13 based on difference data corresponding to the calculation result output from the arithmetic circuit 6. Referring now to FIG. 2, a description is given of the internal configuration of the optimization control circuit 7. The optimization control circuit 7 includes an equalizer 71, a low-pass filter 72, a comparator 73, and an optical disk controller 74.

An input of the equalizer 71 is connected to an output of the operational amplifier 62, and an output of the equalizer 71 is connected to an input of the low-pass filter 72. An input of the comparator 73 is connected to an output of the low-pass filter 72, and an output of the comparator 73 is connected to an input of the optical disk controller 74. Further, an output of the optical disk controller 74 is connected to the gain adjustment circuit 61. Note that the output of the optical disk controller 74 is connected to an output interface 14.

Referring next to FIGS. 1 and 2, operations of the optical disk device 100 configured as described above are described in detail below. The half mirror 8 is irradiated with the laser light which is output from the laser light output circuit 1 and on which the high-frequency signal is superimposed. In this case, the laser light transmitting through the half mirror 8 is made incident on the light receiving circuit 3.

On the other hand, the laser light reflected by the half mirror 8 is made incident on the collimator lens 9. The collimator lens 9 changes the incident laser light into parallel light. The imaging lens 10 forms the laser light, which is the parallel light emitted from the collimator lens 9, into an image. The laser light formed into an image by the imaging lens 10, is made incident on the optical disk 13. Then, based on the incidence of the laser light, a reflected light is generated on the optical disk 13. The reflected light reflected by the optical disk 13 is return light carrying disk information of the optical disk 13. In this case, the reflected light reflected by the optical disk 13 is made incident on the light receiving circuit 4 via the imaging lens 10, the collimator lens 9, and the cylindrical lens (not shown).

The light receiving circuit 3 outputs the first voltage Vn corresponding to the amount of laser light incident on the light receiving circuit 3, to the delay element 5. Further, the light receiving circuit 4 outputs the second voltage Vm corresponding to the amount of light incident on the light receiving circuit 4, to the arithmetic circuit 6. The delay element 5 delays a change in voltage level of the first voltage Vn output from the light receiving circuit 3, and outputs the first voltage Vn thus obtained to the arithmetic circuit 6. As a result, it is possible to suppress the variation in phase of each of the first voltage Vn output from the light receiving circuit 3 and the second voltage Vm output from the light receiving circuit 4.

The operational amplifier 62 of the arithmetic circuit 6 calculates a difference data between the first voltage Vn and the second voltage Vm, and outputs the difference data. In this case, the first voltage Vn is a voltage generated based on the amount of the laser light on which the high-frequency signal is superimposed. Meanwhile, the second voltage Vm is a voltage generated based on the amount of the return light on which the high-frequency signal is superimposed. Specifically, the arithmetic circuit 6 performs subtraction between a voltage corresponding to the amount of light which carries disk information of the optical disk 13 and on which the high-frequency signal is superimposed, and a voltage corresponding to the amount of the laser light on which the high-frequency signal is superimposed.

The equalizer 71 amplifies a necessary signal level in the same frequency band among the difference data output from the operational amplifier 62 provided in the arithmetic circuit 6. The low-pass filter 72 receives the signal output from the equalizer 71 and blocks signals having high frequencies above the signal band. The comparator 73 binarizes the signal output from the low-pass filter 72 to convert the signal into a digital signal. The optical disk controller 74 calculates an error rate or jitter of the digital signal output from the comparator 73. Then, the optical disk controller 74 outputs a gain adjustment signal gs for minimizing the error rate or jitter, to the gain adjustment circuit 61 of the arithmetic circuit 6.

The gain adjustment circuit 61 adjusts the gain of the first voltage Vn output from the light receiving circuit 3 to a desired level. Then, the operational amplifier 62 newly performs subtraction between the first voltage Vn adjusted by the gain adjustment circuit 61 and the second voltage Vm output from the light receiving circuit 4. Thus, in the arithmetic circuit 6, the high-frequency signal contained in the first voltage Vn and the high-frequency signal contained in the second voltage Vm can be cancelled each other. Then, the calculation result from the arithmetic circuit 6 is output to the optimization control circuit 7. Through the adjustment of the first voltage level, the error of data read out from the optical disk 13 is corrected. After that, the optimization control circuit 7 outputs the optimized reproduction signal Vo. The reproduction signal Vo output from the optimization control circuit 7 is output to the outside of the optical disk device 100 via the output interface 14.

As described above, in the first embodiment, the arithmetic circuit 6 calculates the first voltage Vn corresponding to the laser light output from the laser light output circuit 1, and the second voltage Vm corresponding to the reflected light from the optical disk 13. Further, based on the calculation result from the arithmetic circuit 6, the optimization control circuit 7 generates the gain adjustment signal for controlling the first voltage or the second voltage, and outputs the generated gain adjustment signal to the arithmetic circuit 6. Thus, in the first embodiment, only the high-frequency signal superimposed on the laser light can be cancelled. Accordingly, the optical disk device 100 according to the first embodiment is capable of optimizing and outputting a reproduction signal for reproducing the optical disk 13. In other words, according to the first embodiment, a high-quality read signal can be obtained from the optical disk 13 also in a frequency band close to the superimposed high frequency.

Further, in the first embodiment, the optimization control circuit 7 outputs the gain adjustment signal for adjusting the first voltage level to a desired level, to the gain adjustment circuit. Alternatively, the second voltage level may be adjusted to a desired level. Also in this case, the optical disk device 100 is capable of optimizing and outputting a reproduction signal for reproducing an optical disk.

Furthermore, in the first embodiment, the optical disk device 100 includes the delay element 5 connected to the output of the first light receiving circuit 3. Thus, the optical disk device 100 is capable of correcting a phase error generated between the first voltage Vn output from the first light receiving circuit 3, and the second voltage Vm output from the second light receiving circuit 4. Accordingly, the optical disk device 100 is capable of adjusting the phase of the high-frequency superimposed component to be suppressed.

### Second Embodiment

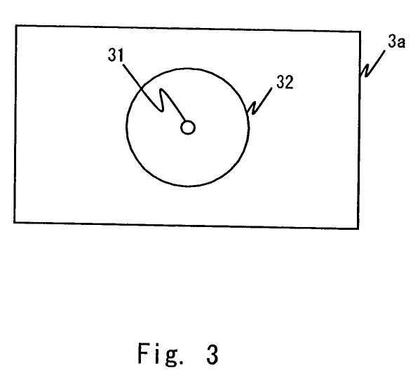

FIG. 3 shows a light receiving circuit 3a of an optical disk device according to a second embodiment of the present invention. Note that, in the second embodiment, the light receiving circuit 3 shown in FIG. 1 is replaced with the light receiving circuit 3a shown in FIG. 3, and the other configuration is identical with that of the optical disk device 100 according to the first embodiment. Accordingly, in the second embodiment, only the configuration and operations of the light receiving circuit 3a will be described.

In a similar manner as in the light receiving circuit 3 according to the first embodiment, the light receiving circuit 3a receives laser light on which a high-frequency signal output from the laser light output circuit 1 is superimposed. The light receiving circuit 3a includes a broadband light receiving section 31 and a narrowband light receiving section 32. The narrowband light receiving section 32 has an area larger than that of the broadband light receiving section 31. Further, in the second embodiment, the broadband light receiving section 31 and the narrowband light receiving section 32 each have a circular shape, but may have shapes other than the circular shape. The broadband light receiving section 31 and the narrowband light receiving section 32 are arranged concentrically with the broadband light receiving section 31 as a center. Alternatively, the broadband light receiving section 31 may be placed in any position within the narrowband light receiving section 32.

The laser light output from the laser light output circuit 1 is made incident on the broadband light receiving section 31 of the light receiving circuit 3a configured as described above. Further, as exemplified in the first embodiment, the high-frequency signal of about 350 MHz to 450 MHz, for example, is superimposed on the laser light output from the semiconductor laser 11. As a result, the light receiving circuit 3a can detect the laser light on which the high-frequency signal is superimposed, in the broadband light receiving section 31.

As described above, in the second embodiment, the broadband light receiving section 31 and the narrowband light receiving section 32 having an area larger than that of the broadband light receiving section 31 are provided in the light receiving circuit 3a. As a result, according to the second embodiment, it is possible to detect the laser light on which the high-frequency signal is superimposed, in the broadband light receiving section 31, without reducing the area of the light receiving circuit 3a. Accordingly, in the second embodiment, the light receiving circuit 3a is capable of maintaining a function of monitoring the amount of emitted laser light itself, and detecting the laser light on which the high-frequency signal is superimposed.

Although the present invention has been described with reference to the embodiments, various modifications can be made without departing from the gist of the present invention.

It is apparent that the present invention is not limited to the above embodiment but may be modified and changed without departing from the scope and spirit of the invention.

What is claimed is:

1. An optical disk device to output a reproduction signal to reproduce an optical disk, comprising:
a light output circuit to output light having a high frequency superimposed thereon;
a first light receiving circuit to receive the light to output a first voltage corresponding to an amount of the light;
a second light receiving circuit to output a second voltage corresponding to an amount of reflected light from the optical disk;
an arithmetic circuit to output a calculation result based on a difference between the first voltage and the second voltage; and
a reproduction signal generating circuit to control one of the first voltage and the second voltage based on the calculation result to generate the reproduction signal to reproduce the optical disk.

2. The optical disk device according to claim 1, wherein the reproduction signal generating circuit generates a gain adjustment signal to adjust a gain of one of the first voltage and the second voltage based on the calculation result, and outputs the gain adjustment signal to the arithmetic circuit.

3. The optical disk device according to claim 1, wherein the arithmetic circuit includes:
a gain adjustment circuit to adjust a gain of one of the first voltage and the second voltage based on a gain adjustment signal; and
a comparator to output the calculation result corresponding to a difference between the first voltage and the second voltage, to the reproduction signal generating circuit, the gain of the first voltage being adjusted.

4. The optical disk device according to claim 1, wherein the first light receiving circuit has a first light receiving surface and a second light receiving surface having an area larger than that of the first light receiving surface, and receives the light at the first light receiving surface.

5. The optical disk device according to claim 4, wherein the first light receiving surface and the second light receiving surface are arranged concentrically.

6. The optical disk device according to claim 1, further comprising a phase error correcting circuit to correct a phase error between the first voltage and the second voltage.
